(19) United States
(12) Patent Application Publication
(10) Pub. No.: US 2024/0254015 A1
(43) Pub. Date: Aug. 1, 2024

(54) WASTEWATER REUSE SYSTEM

(71) Applicant: Kraus USA Plumbing LLC, Port Washington, NY (US)

(72) Inventors: Serhiy Torak, Brooklyn, NY (US); Todd Alexander, Hollis, NH (US)

(21) Appl. No.: 18/412,011

(22) Filed: Jan. 12, 2024

Related U.S. Application Data
(60) Provisional application No. 63/441,277, filed on Jan. 26, 2023.

(51) Int. Cl. C02F 1/44; C02F 1/32

(52) U.S. Cl. CPC C02F 1/441; C02F 1/32; C02F 2201/326; C02F 2209/42; C02F 2303/04; C02F 2307/06

(57) ABSTRACT

A wastewater reuse system including a wastewater tank configured to treat wastewater from a contaminant side of a water treatment device, such as a reverse osmosis (RO) filtration system, such that the treated water can then be delivered to a fluid delivery device (e.g., a faucet, a side sprayer, etc.) for reuse.

### CROSS-REFERENCE TO RELATED APPLICATION

The present application claims priority to U.S. Provisional Patent Application Ser. No. 63/441,277, filed Jan. 26, 2023, the disclosure of which is expressly incorporated herein by reference.

### BACKGROUND AND SUMMARY OF THE INVENTION

The present invention relates generally to a residential wastewater system and, more particularly, to such a system receiving wastewater from a water treatment device and repurposing the wastewater for reuse.

Water treatment systems (e.g., reverse osmosis (RO) filtration systems and water softeners) are common in many homes. However, the contaminant or wastewater discharge from these treatment systems are generally sent to a waste drain. If this wastewater could be reused, it would help substantially conserve water. It may also provide more justification for the use of RO water in other home applications that may otherwise be too wasteful given the ratio of discharge wastewater to RO water. For example, conventional RO filtration systems typically use four gallons of water to purify one gallon of water (i.e., ratio of 4:1).

The present invention relates to a wastewater reuse system including a wastewater tank configured to treat wastewater from the contaminant (“dirty”) side of a water treatment device, such as a reverse osmosis (RO) filtration system, such that the treated wastewater can then be delivered to a fluid delivery device (e.g., a faucet, a side sprayer, a showerhead, etc.) for reuse.

According to an illustrative embodiment of the present disclosure, a wastewater reuse system includes a faucet, a water treatment device fluidly coupled to a cold water source, and a wastewater tank fluidly coupled to the water treatment device. The wastewater tank includes an inner housing having a top surface and a bottom surface, and a water level sensor supported by the inner housing to detect a level of wastewater within the inner housing. An ultraviolet light is supported by the inner housing to treat the wastewater, and an electrically operable valve is supported by the inner housing. A controller is operably coupled to the water level sensor, the ultraviolet light and the electrically operable valve. The wastewater tank is fluidly coupled to the faucet to provide the treated wastewater to the faucet. The controller controls the electrically operable valve to provide selective fluid communication between the faucet and one of the cold water source or the inner housing of the wastewater tank.

According to another illustrative embodiment of the present disclosure, a wastewater reuse system includes a water treatment device and a wastewater tank. The wastewater tank is fluidly coupled to the water treatment device to provide wastewater to the wastewater tank. The wastewater tank includes a water level sensor configured to detect a level of wastewater, an ultraviolet light configured to treat the wastewater, and an electrically operable valve. A controller is operably coupled to the water level sensor, the ultraviolet light and the electrically operable valve. Illustratively, the wastewater tank is fluidly coupled to at least one faucet to provide the treated wastewater to the at least one faucet. In an illustrative embodiment, the at least one faucet includes a primary faucet and a secondary faucet, wherein the wastewater tank is fluidly coupled to the secondary faucet to provide the treated wastewater to the secondary faucet.

According to a further illustrative embodiment of the present disclosure, a wastewater reuse system includes a hot water source, a cold water source, a fluid delivery device fluidly coupled to the hot water source, and a water treatment device fluidly coupled to the cold water source. A wastewater tank is fluidly coupled to the water treatment device to provide wastewater to the wastewater tank. An electrically operable valve is fluidly coupled to the cold water source and configured to selectively provide fluid communication to the fluid delivery device from either the cold water source or the wastewater tank. A pump is configured to move treated wastewater from the wastewater tank to the fluid delivery device. A controller is operably coupled to the electrically operable valve and the pump. Illustratively, the fluid delivery device comprises a faucet.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

A detailed description of the drawings particularly refers to the accompanying figures, in which:

FIG. 1 is a diagrammatic view of an illustrative wastewater reuse system of the present disclosure;

FIG. 2 is another diagrammatic view of the illustrative wastewater reuse system of FIG. 1;

FIG. 3 is logic block diagram of the illustrative wastewater reuse system of FIG. 1;

FIG. 4 is a perspective view of an illustrative wastewater tank of the wastewater reuse system of FIG. 1, with portions of the outer housing and the inner housing removed for clarity;

FIG. 5 is a further perspective view of the illustrative wastewater tank of FIG. 4;

FIG. 6 is a further perspective view of the illustrative wastewater tank of FIG. 4;

FIG. 7A is a partial diagrammatic view of the illustrative wastewater reuse system of FIG. 1;

FIG. 7B is a detailed perspective view of the cold water valve of FIG. 7A;

FIG. 8 is a cross-sectional view of the cold water valve of FIG. 7B;

FIG. 9 is a diagrammatic view of an illustrative wastewater reuse system of the present disclosure;

FIG. 10 is a diagrammatic view of an illustrative wastewater reuse system of the present disclosure;

FIG. 11 is a top view of a cabinet receiving the illustrative wastewater reuse system of FIG. 10;

FIG. 12 is a front view of the cabinet receiving the illustrative wastewater system of FIG. 11;

FIG. 13 is a front perspective view of another illustrative wastewater tank of the present disclosure;

FIG. 14 is a rear perspective view of the illustrative wastewater tank of FIG. 13;

FIG. 15 is a front perspective view of the illustrative wastewater tank of FIG. 13, with portions of outer housing and the inner housing removed for clarity; and

FIG. 16 is a top plan view of the illustrative wastewater tank of FIG. 15, with portions of the outer housing removed for clarity.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

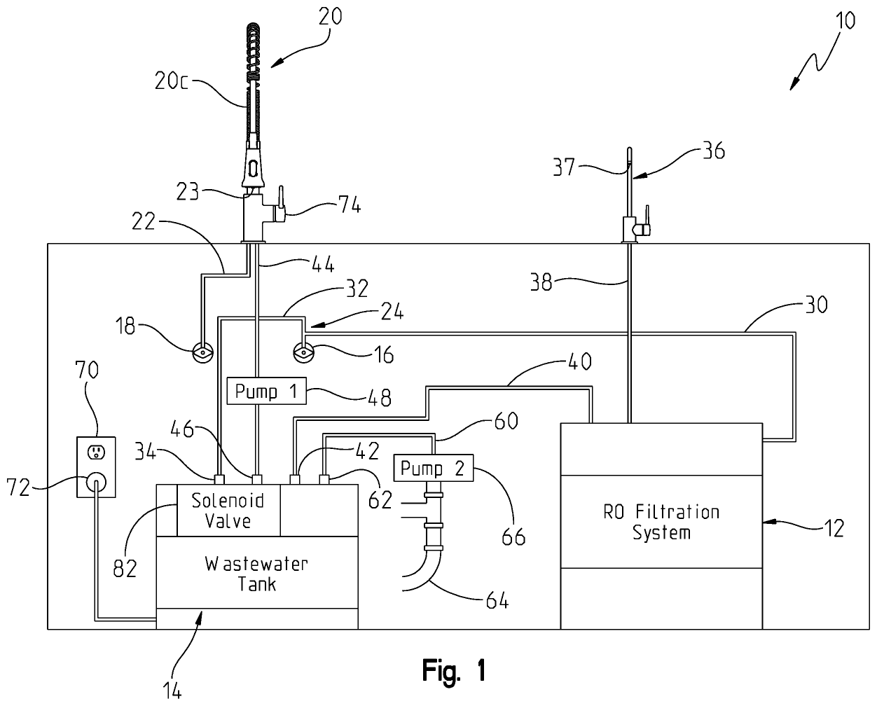

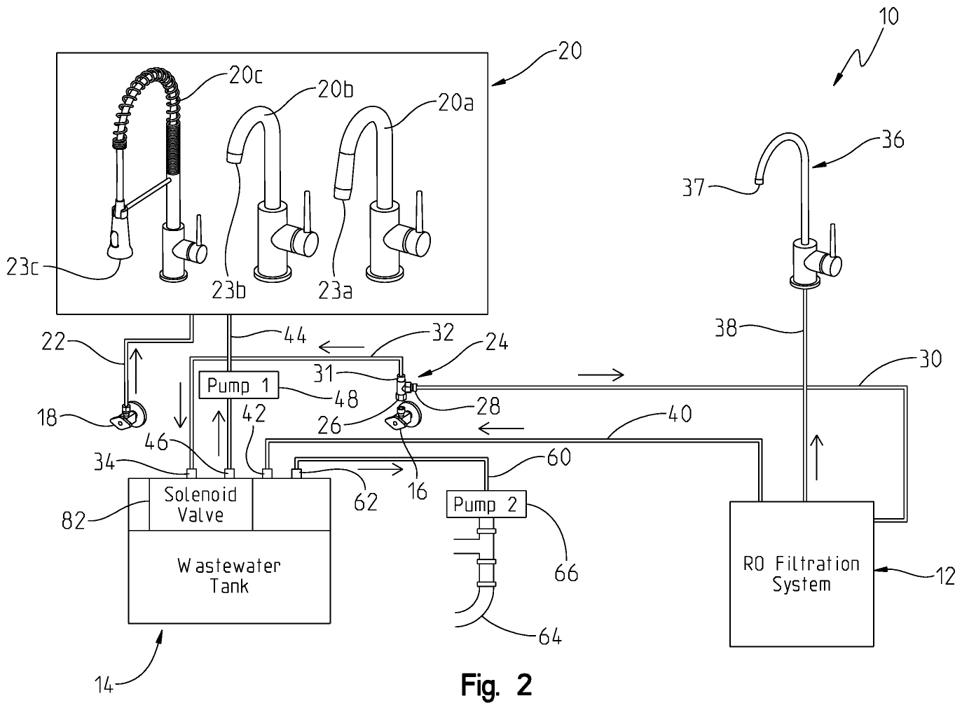

FIGS. 1-2 show an illustrative wastewater reuse system 10 including a water treatment device 12, illustratively shown as a reverse osmosis (RO) filtration system, and a wastewater tank 14. The wastewater tank 14 is illustratively a non-pressure bearing tank configured to collect and treat wastewater, as further detailed herein. A cold water source 16 (illustratively a cold water valve or stop) and a hot water source 18 (illustratively a hot water valve or stop) provide cold and hot water, respectively, to the wastewater reuse system 10. The hot water source 18 is fluidly coupled to a first or primary fluid delivery device 20, illustratively a faucet, via a hot water line 22 to provide hot water to the faucet 20 for delivery from a water outlet 23. Faucet 20 may be any typical kitchen sink faucet including, for example, a pull-down faucet 20a, a fixed faucet 20b, and all-in-1 (e.g., spring spout) faucet 20c (FIG. 2). An illustration faucet 20c is shown in U.S. Pat. No. 11,085,175 to Fourman et al., the disclosure of which is expressly incorporated herein by reference.

According to the illustrative embodiment as shown in FIGS. 2 and 7A-8, the cold water source 16 is fluidly coupled to a conventional fluid connector, such as a valve 24. Illustratively, the valve 24 is a 3-port valve assembly. The cold water source 16 is fluidly coupled to a first port 26 of the valve 24. A second port 28 of the valve 24 is fluidly coupled to the water treatment device 12 via a cold water line 30 to provide cold water to the water treatment device 12. A third port 31 of the valve 24 is fluidly coupled to the wastewater tank 14 via a cold water inlet line 32 to provide cold water directly to the wastewater tank 14. Cold water inlet line 32 is fluidly coupled to the wastewater tank 14 through a conventional connector 34. In one illustrative embodiment, cold water inlet line 32 is a stainless steel, braided pipe. In one illustrative embodiment, connector 34 is a threaded connector, such as a 9/16-24UNEF hose connector.

With further reference to FIGS. 1 and 2, the illustrative water treatment device 12 uses a filtration method to treat the cold water. In one illustrative embodiment, the water treatment device 12 is a reverse osmosis (RO) filtration system which uses a known method of filters and membranes to treat the cold water. Water treatment device 12 can be any known reverse osmosis filtration system. An illustrative reverse osmosis filtration system is shown in PCT International Patent Application No. PCT/US23/26646, filed Jun. 29, 2023, the disclosure of which is expressly incorporated herein by reference. The water treatment device 12 may provide treated water to a filtered water outlet defined by a second fluid delivery device 36, illustratively a secondary faucet, via treated water line 38. Illustratively, the secondary faucet 36 is a conventional beverage or drinking water faucet including a water outlet 37. While separate fluid delivery devices or faucets 20 and 36 are shown, it should be appreciated that the water outlets 23 and 37 may be defined by a single fluid delivery device or faucet.

The wastewater from the contaminant (or “dirty”) side of the water treatment device 12 is provided to the wastewater tank 14 via a wastewater line 40. Wastewater line 40 is fluidly coupled to the wastewater tank 14 through a connector 42. In one illustrative embodiment, the connector 42 is a conventional quick connector, such as an inner hole 2″ (6.35 mm), external thread 9/16-24UNEF hose connector.

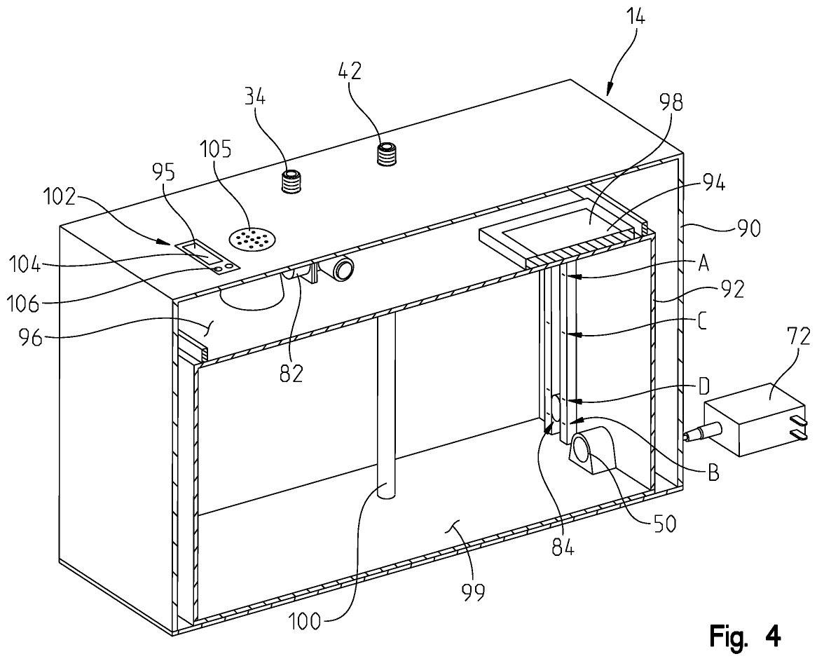

In the illustrative embodiment as shown in FIGS. 1, 2, 4 and 5, the wastewater tank 14 includes an ultraviolet (UV) treatment device 50 (FIG. 4) that treats (e.g., sterilizes) the wastewater from the water treatment device 12. The treated wastewater can then be supplied to the primary faucet 20 from the wastewater tank 14 via a cold water outlet line 44. The cold water outlet line 44 is fluidly coupled to the wastewater tank 14 through a conventional connector 46. In one illustrative embodiment, connector 46 is a threaded 9/16-24UNEF connector.

With further reference to FIGS. 1, 2, 4 and 5, a first or faucet pump 48 illustratively moves the treated (e.g., sterilized) water from the wastewater tank 14 to the primary faucet 20. The faucet pump 48 may be configured to increase the pressure and volume of water flowing to the faucet 20. In one illustrative embodiment, the pump 48 has a voltage of 6-14 Volts. In one illustrative embodiment, the pump 48 has a flow of 5.2-6.7 liters per minute. In one illustrative embodiment, the faucet pump 48 has a pump lift of greater than 2 meters. In one illustrative embodiment, the faucet pump 48 has a life cycle of greater than 20,000 hours.

An overflow line 60 is fluidly coupled to the wastewater tank 14 through a conventional connector 62. In one illustrative embodiment, the connector 62 is a quick connector, such as an inner hole 2 inch (6.35 mm), external thread 9/16-24UNEF connector. Overflow line 60 illustratively directs excess water in the wastewater tank 14 to a waste drain 64 (e.g., a drainage pipe). Illustratively, a second or drain pump 66 helps flush the overflow water through overflow line 60 and into the drain 64. In one illustrative embodiment, the drain pump 66 has a voltage of 8-15 Volts. In one illustrative embodiment, the pump 66 has a flow of 4.5-5.5 liters per minute, and a pump lift of greater than 1.5 meters. In one illustrative embodiment, the drain pump 66 has a life cycle of greater than 20,000 hours.

With further reference to FIG. 1, the wastewater tank 14 illustratively connects to a standard wall outlet 70 through a power supply 72. Illustratively, power supply 72 is a 12V DC power supply.

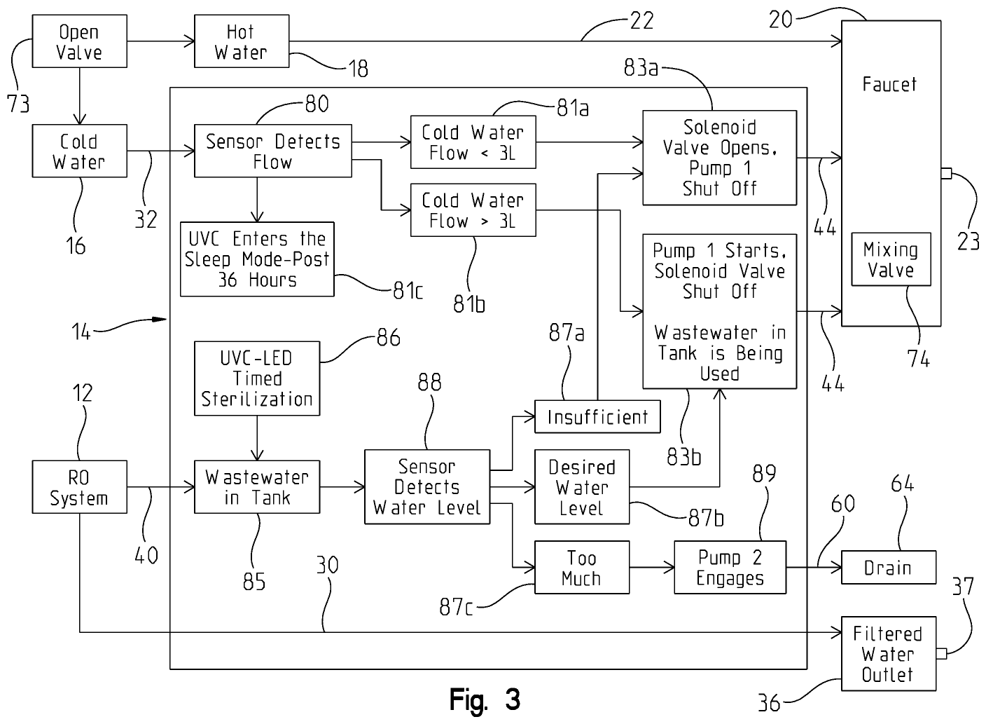

FIG. 3 is a logic block diagram of the illustrative wastewater reuse system 10. At block 73, by opening the hot water valve 18, hot water is illustratively provided directly to a manual control valve 74 of the faucet 20 via the hot water line 22. The control valve 74 may control the flow of water therethrough to the water outlet 23 in a known manner (FIG. 2). The control valve 74 illustratively comprises a conventional mixing valve including a handle operably coupled to a movable valve member (not shown) for controlling the flow rate and the temperature of water delivered to the water outlet 23.

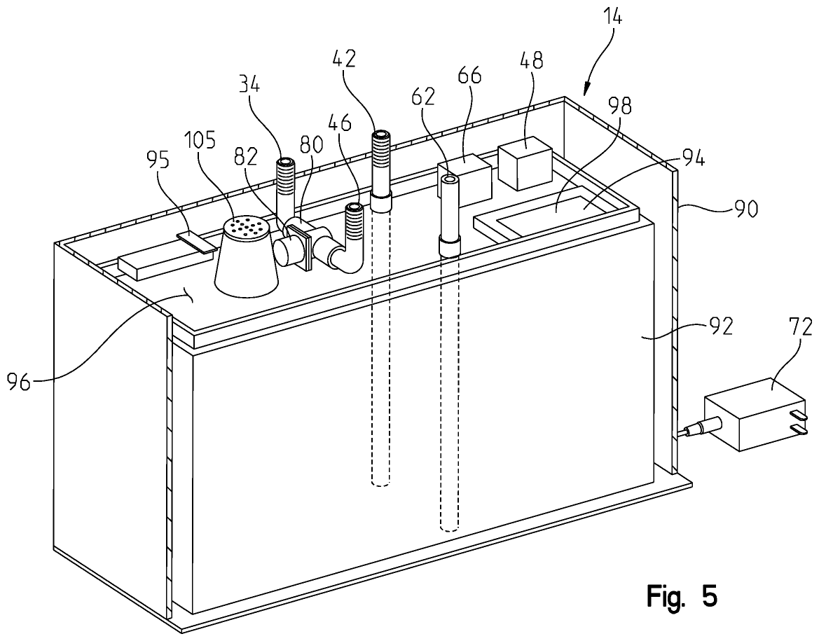

Returning to block 73 of FIG. 3, by opening the cold water valve 16, cold water is illustratively provided directly to the wastewater tank 14 through the cold water inlet line 32. A water flow sensor 80, illustratively a Hall-effect sensor, may detect the water flow of the cold water provided to the tank 14 (FIG. 5). With reference to FIGS. 4 and 5, an electrically operable valve 82 (e.g., a solenoid valve) is positioned intermediate the connector 34 of the cold water inlet line 32 and the connector 46 of the cold water outlet line 44.

More particularly, if the measured water flow volume is below a predetermined value (e.g., 3 liters as shown at block 81a), the electrically operable valve 82 opens and the faucet pump 48 is shut off (as shown at block 83a). This allows the cold water to flow directly from the cold water line 30 to the faucet 20 through the cold water outlet line 44. If the measured water flow volume is greater than a predetermined value (e.g., 3 liters, as shown at block 81b), the solenoid valve 82 is closed and the faucet pump 48 is activated (as shown at block 83b). This allows treated wastewater in the wastewater tank 14 to flow through cold water outlet line 44 to the primary faucet 20. If a predetermined time elapses without operation of the faucet 20 as determined by the water flow sensor 80 (as shown at block 81c), then the system 10 illustratively enters a sleep mode (as further detailed herein).

With further reference to FIG. 3, wastewater from the water treatment device 12 is provided to the wastewater tank 14 through the wastewater line 40 (as shown at block 85). A liquid or water level sensor 84 illustratively detects the water level of the wastewater in the tank 14 at block 88. If the measured water level is below a predetermined value (as shown at block 87a), the solenoid valve 82 opens and the pump 48 is shut off. This allows cold water from cold water source 16 to flow directly through cold water outlet line 44 to the faucet 20. If the measured water level in the tank 14 is at a desired level (as shown at block 87b), the solenoid valve 82 is closed and the pump 48 is activated (as shown at block 89). This allows sterilized wastewater in the wastewater tank 14 to flow through the cold water outlet line 44 to the faucet 20. If the measured water level in the tank 14 is above a predetermined value (as shown at block 87c), the pump 66 is activated and the excess wastewater is sent to the drain 64 through overflow line 60.

With further reference to FIG. 4, different volumes of water within the wastewater tank 14 are represented by water levels A, B, C, D as illustratively detected by the water level sensor 84. A represents a maximum water lever (e.g., approximately 15.5 liters). When the sensor 84 detects water at level A, then the drain pump 66 starts draining the tank 14. B represents a minimum water level (e.g., approximately 2 liters). When the sensor 84 detects water at or below level B, then the system 10 stops using wastewater and automatically switches to tap water. More particularly, the electrically operable valve 82 opens and the faucet pump 48 is shut off. C represents a drainage control level (e.g., approximately 10 liters). When the tank 14 is draining, the water volume will be reduced from level A to level C at which point the drainage will stop automatically (e.g., by deactivating the drain pump 66). D represents a protection water level (e.g., approximately 5 liters). Only when the water level is above D, can the faucet pump 48 controlling wastewater be started in order to avoid frequent starting and stopping of the pump 48.

FIGS. 4-6 show the illustrative wastewater tank 14 including an outer housing 90 receiving an inner housing 92. The outer housing 90 includes a height H and a length L. In one illustrative embodiment, the height H is 300 mm, and the length L is 490 mm. In one illustrative embodiment, the outer housing 90 is made of acrylonitrile butadiene styrene (ABS). The outer housing 90 illustratively supports a vent 105 to prevent water pressure in the wastewater tank 14. The solenoid valve 82, Hall-effect sensor 80, the fluid connectors 34, 42, 46, 62, the faucet pump 48, the drain pump 66, a printed circuit board (PCB) 94, and a manual drainage button 95 are illustratively supported on a top surface 96 of the inner housing 92. Illustratively, the pumps 48, 66 may be received within or positioned external to the outer housing 90 and/or the inner housing 92. The printed circuit board 94 illustratively supports a controller 98, such as a microprocessor.

The inner housing 92 is where water is stored in the wastewater tank 14. In one illustrative embodiment, the storage area or volume of the inner housing 92 is 15 liters. In one illustrative embodiment, the inner housing 92 is made of recycled plastics. Illustratively, a tube 100 is fluidly connected to connector 42 to allow wastewater to flow into the inner tank 92. In one illustrative embodiment, the tube 100 is made of a polymer, such as silicone. The inner housing 92 illustratively includes the liquid level sensor 84 that measures the liquid level in the wastewater tank 14. Illustratively, the liquid level sensor 84 may be any conventional device, such as a Hall-effect sensor cooperating with a float ball. In an illustrative embodiment, the liquid level sensor 84 is located closer to a bottom surface 99 of the inner housing 92.

The controller 98 of the wastewater tank 14 takes various actions depending on the amount of liquid measured by the liquid level sensor 84. When a maximum storage water level (A on FIG. 4B) is measured, the wastewater tank 14 starts to drain automatically by activating the drain pump 66. In one illustrative embodiment, this level is plus or minus 15.5 liters. When the wastewater tank 14 is draining, once a drainage control level (B on FIG. 4B) is measured, the drainage will be automatically stopped by deactivating the drain pump 66. In one illustrative embodiment, this level is plus or minus ten liters. When a minimum water level (C on FIG. 4B) is measured, the controller 98 operates the electrically operable valve 92 such that the wastewater tank 14 stops providing wastewater to the faucet 20 and switches to providing cold water from the cold water source 16 to the faucet 20. In one illustrative embodiment, this level is plus or minus 2 liters. The amount of wastewater measured must be greater than a protection water level (D on FIG. 4B) to activate the faucet pump 48 to avoid frequent startup and shutdown of the faucet pump 48. In one illustrative embodiment, this level is plus or minus five liters.

The illustrative wastewater tank 14 also includes a sleep mode. When it is detected that the faucet 20 has not been used for a defined period of time, the drain pump 66 will automatically drain the water in the tank 14. The remaining water volume will be less than 0.5 liters. In one illustrative embodiment, the defined period of time is 36 hours. When the use of the faucet 20 is detected, the wastewater tank 14 will engage in a normal working mode.

The manual drainage button 95 can be used by a user if it is desired to remove or clean the wastewater tank 14. When the user engages the manual drainage button 95, the controller 98 will activate the drain pump 66 such that the wastewater tank 14 will discharge the wastewater inside. The remaining wastewater volume in the wastewater tank 14 will be less than 0.5 liters.

In an illustrative embodiment, the wastewater tank 14 may also include a deep cleaning mode. A user would connect the cold water line 32 to the connector 42. The user would manually control the angle stop valve 16 to supply water to the wastewater tank 14. In one illustrative embodiment, the wastewater tank 14 would include an automatic deep cleaning mode (e.g., occurs on a periodic basis without direct user input).

The inner housing 92 illustratively includes the UV sterilization device 50 to prevent bacteria from growing with the stored wastewater. In one illustrative embodiment, the UV sterilization device 50 is a Shenzhen NiceUV Optics Co., Ltd. system. In one illustrative embodiment, the power is 10-15 mW. In one embodiment, the wave length is 270-280 nm, and the voltage is 12 VDC-24 VDC. In one illustrative embodiment, the temperature range is −25° C.-50° C., and the life cycle of the UV sterilization system 50 is greater than 10,000 hours (more than 10 years). In one illustrative embodiment, the sterilization rate is greater than 99.9%.

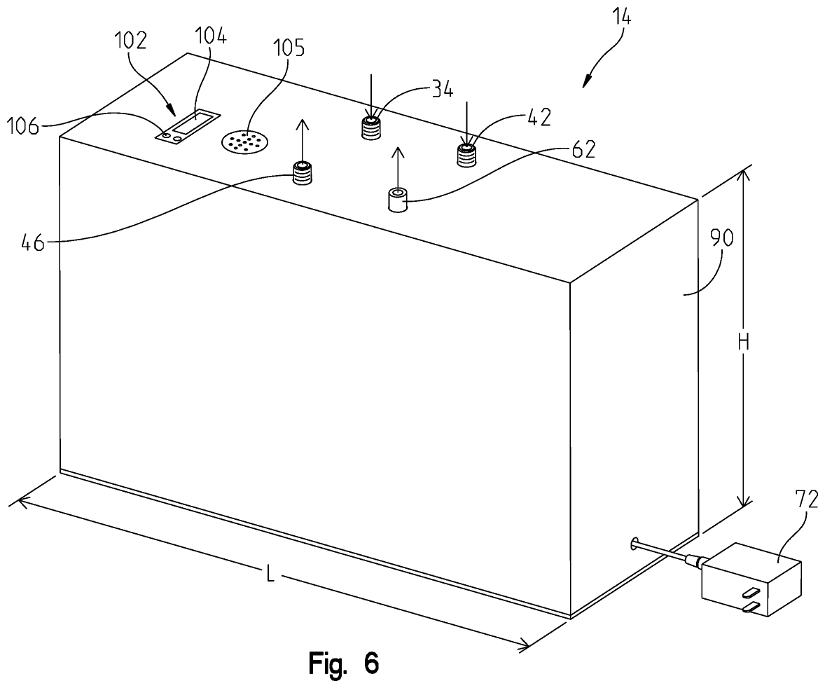

With reference to FIG. 6, the outer housing 90 illustratively includes a user interface or control panel 102 having a display screen 104 and a UV input button 106. For the first time use, a user presses and holds the UV button 106 for three seconds. The UV sterilization device 50 will then sterilize for two hours to sterilize the internals of the tank. The UV sterilization device 50 illustratively enters bacteriostasis mode every two hours, working for ten minutes. The UV sterilization device 50 illustratively enters sterilization mode every 24 hours, working for one hour. In the sleep mode, the UV sterilization device 50 will work for ten minutes every twelve hours. When the use of the faucet 20 is detected, the UV sterilization device 50 will resume normal working mode. If there is a failure of the UV sterilization device 50, the screen 104 will flash and an audible alert (e.g. a beep) will emit from an audible device (not shown) on the PCB 94. Normal function of the UV sterilization device 50 will cease and the system 10 will be bypassed to a standard RO application.

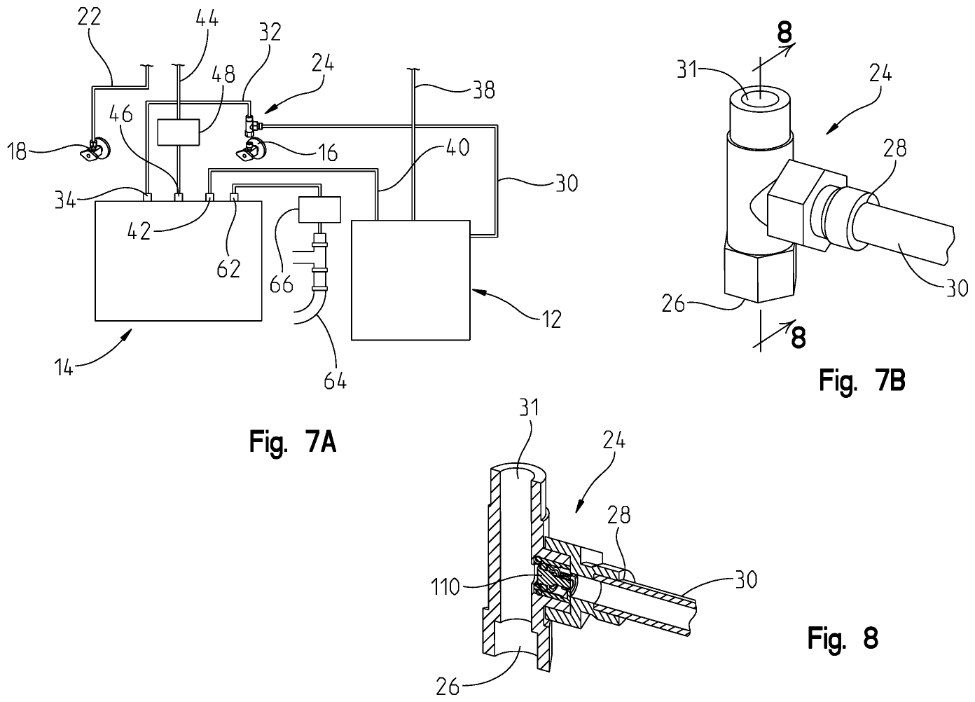

FIGS. 7A, 7B and 8 show additional details of the illustrative valve 24. Illustratively, valve 24 is a 3-port valve assembly including first port 26, second port 28, and third port 31. The ports 26, 28, 31 may include quick-connect couplers. The second port 28 of the valve 24 is fluidly coupled to the water treatment device 12 via cold water line 30 to provide cold water to the water treatment device 12. In one illustrative embodiment, valve 24 is made of a low lead copper. Valve 24 illustratively includes a one-way valve 110 (e.g., a check valve) that allows cold water to flow through first port 26 from the cold water source 16 to cold water line 30, but does not allow water in cold water line 30 to flow back into valve 24. In one illustrative embodiment, the first port 26 is a thread connector 9/16-24UNEF.

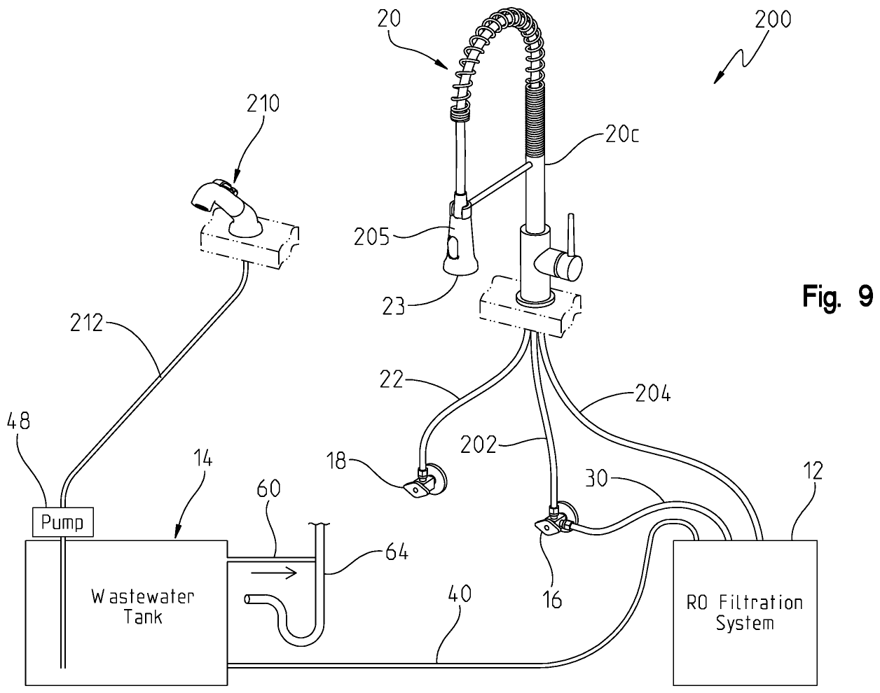

FIG. 9 shows another illustrative embodiment wastewater reuse system 200 including many elements similar to those of the wastewater reuse system 10 as detailed above. As such, in the following description similar features are identified with like reference numbers. Cold water is provided from a cold water source 16 to a faucet 20 through a cold water line 202. Hot water is provided from a hot water source 18 to the faucet 20 through hot water line 22. Cold water is also provided from cold water source 16 to water treatment system 12 through cold water line 30. The faucet 20 may be a spring spout faucet 20c including a removable sprayhead 205 defining the water outlet 23.

The illustrative water treatment device 12 uses a filtration method to treat the cold water. In one illustrative embodiment, the water treatment device 12 is a reverse osmosis (RO) filtration system which uses a known method of filters and membranes to treat the cold water. Water treatment device 12 can be any known reverse osmosis filtration system.

The illustrative water treatment device 12 provides treated water to the faucet 20 through a treated water line 204. The wastewater from the contaminant (or “dirty”) side of the water treatment device 12 is provided to the wastewater tank 14 via wastewater line 40. In an illustrative embodiment, the wastewater tank 14 includes an ultraviolet (UV) treatment device 50 (see, e.g., FIG. 4) that treats (e.g., sterilizes) the wastewater from the water treatment device 12. The treated wastewater can then be supplied to a secondary or auxiliary faucet 210 through a treated wastewater line 212. Faucet pump 48 illustratively moves the sterilized water from the wastewater tank 14 to the faucet 210. Faucet pump 48 may be configured to increase the pressure and volume of water flowing to the faucet 210. Overflow line 60 is illustratively coupled to the wastewater tank 14. Excess water in the wastewater tank 14 may be sent to the waste drain 64 through overflow line 60 as further described above.

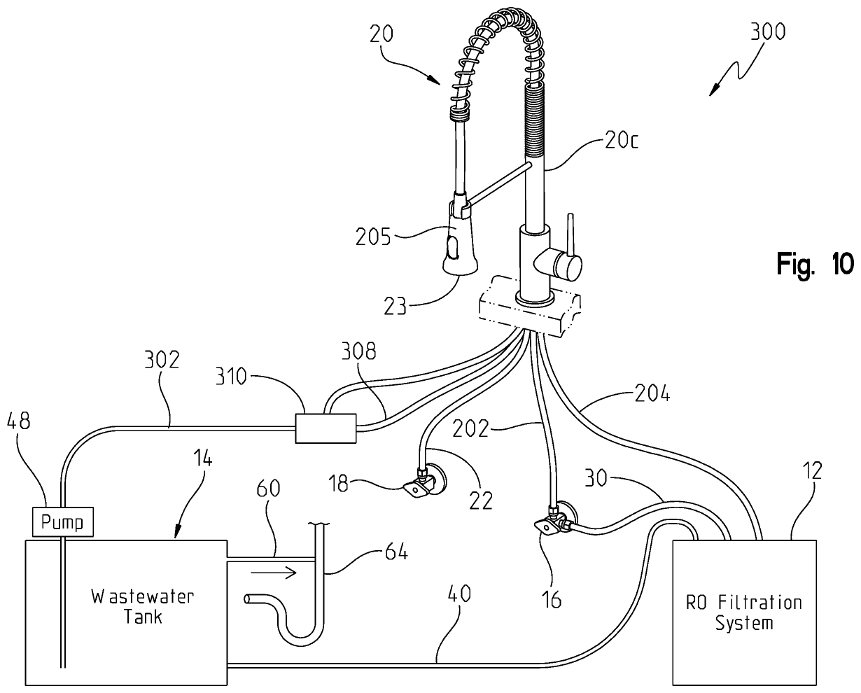

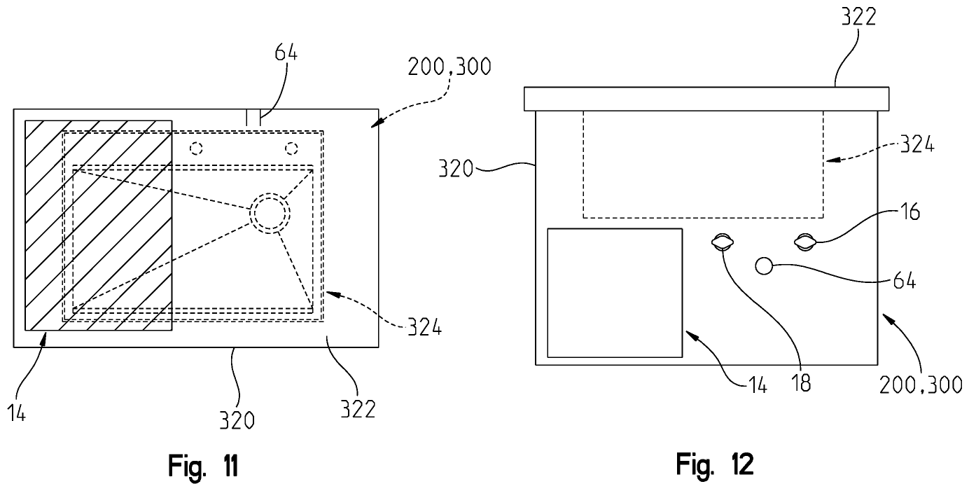

FIG. 10 shows another illustrative embodiment wastewater reuse system 300 similar to wastewater reuse system 200 wherein similar features are identified with like reference numbers. In the illustrative wastewater reuse system 300, water in the wastewater tank 14 is provided to the faucet 20 rather than a secondary faucet. The sterilized water is provided to faucet 20 through a sterilized water line 302. The faucet 20 may be a spring spout faucet 20c including sprayhead 205 fluidly coupled to the sterilized water line 302 via an outlet water line 308. The outlet water line 308 may be retracted within a hose box 310.

FIG. 11 is a top view of the illustrative waterway reuse system 200, 300 installed within a cabinet 320. FIG. 12 is a front view of the wastewater reuse system 200, 300 within the cabinet 320 of FIG. 11. The illustrative cabinet 320 includes an upper countertop 322 supporting a sink basin 324.

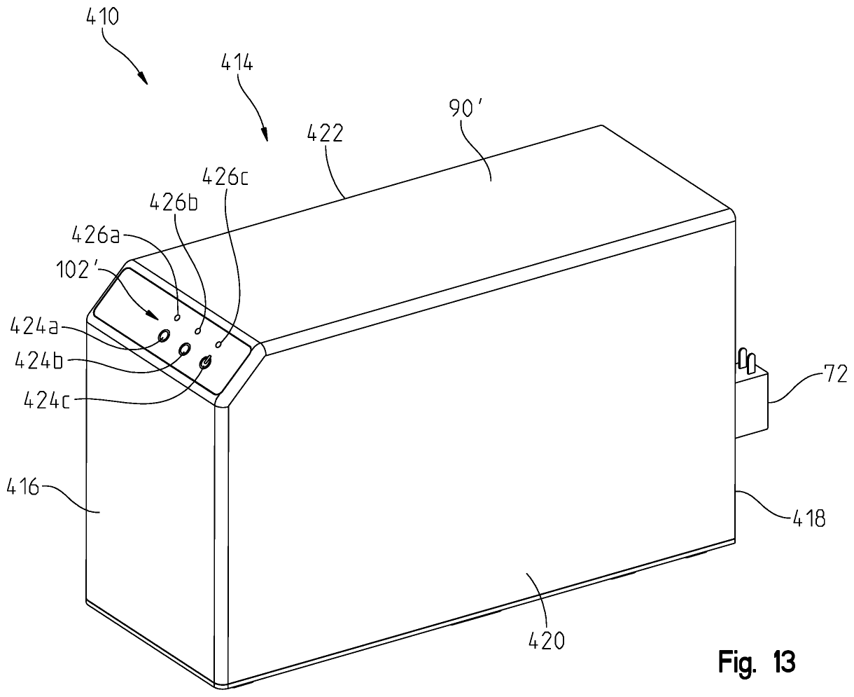

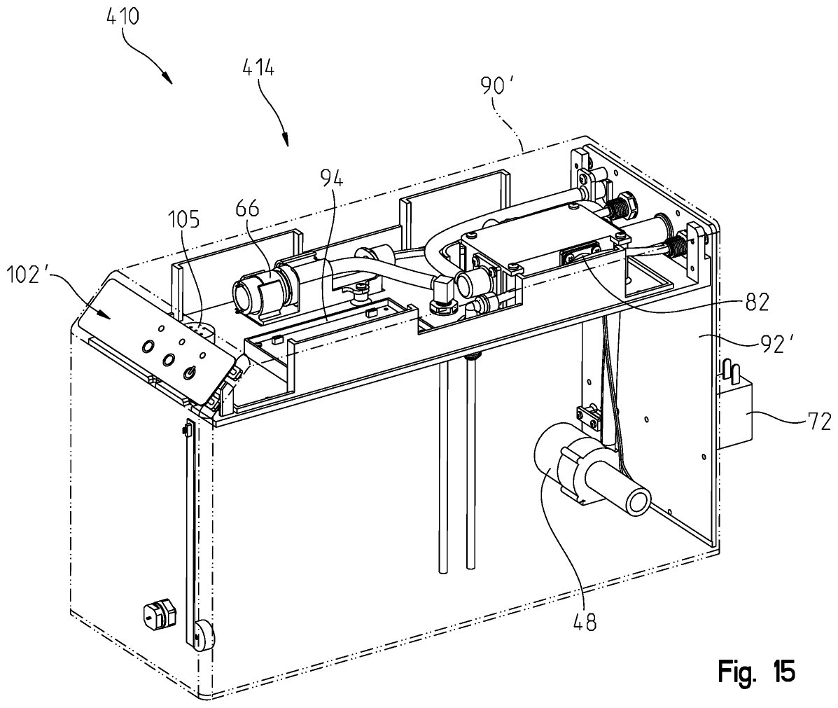

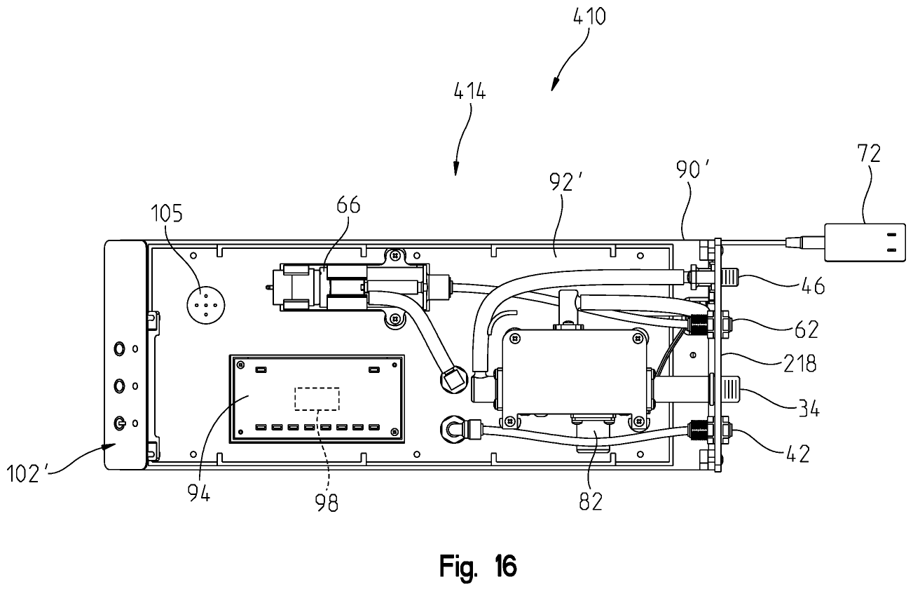

FIGS. 13-16 show a further illustrative wastewater reuse system 410 including a wastewater tank 414. The wastewater reuse system 410 illustratively includes many similar features as the wastewater reuse system 10 detailed above. As such, similar elements are identified with like reference numbers.

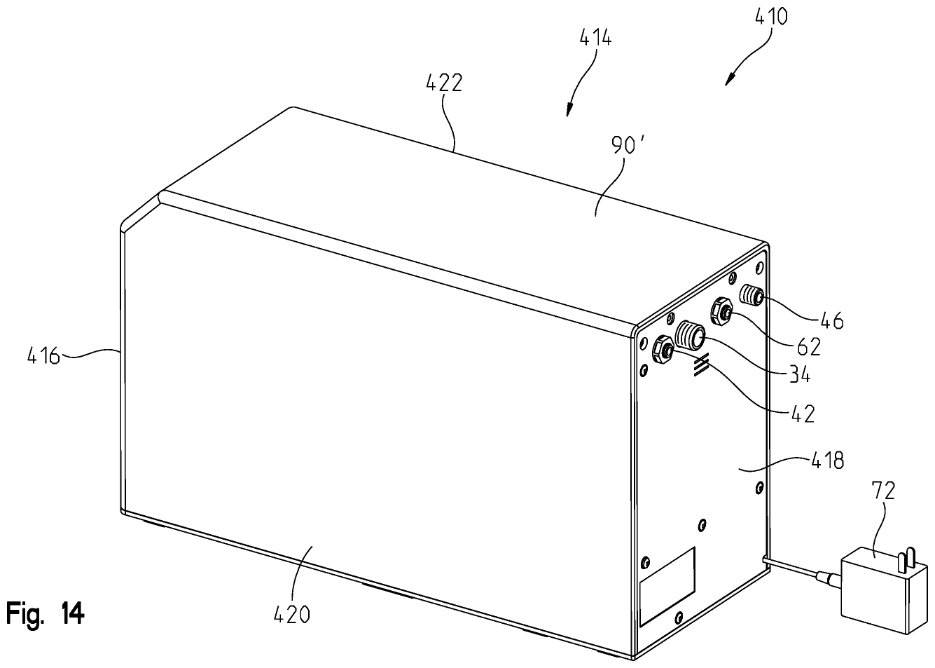

The illustrative wastewater tank 414 includes an outer housing 90′ receiving an inner housing 92′. The outer housing 90′ includes a front wall 416, a rear wall 418, and opposing side walls 420, 422. A user interface or control panel 102′ of the wastewater tank 414 is illustratively supported by the front wall 416 (FIG. 13). In the illustrative wastewater tank 414, the connector 34 for the cold water inlet line 32, the connector 42 for the wastewater line 40, the connector 46 for the cold water outlet line 44, and the connector 62 for the overflow line 60 are all supported by the rear wall 418 (FIG. 14).

The user interface 102′ is operably coupled to the controller 98, and illustratively includes input buttons 424a, 424b, 424c and associated light indicators 426a, 426b, 426c. The input button 424a is illustratively a sterilization button wherein a user depressing the input button 424a activates the UV sterilization device 50 for a predetermined time and/or cycle, in a manner similar to that detailed above. The light indicator 426a is illustratively illuminated when the UV sterilization device 50 is active. The input button 424b is illustratively a drainage button wherein a user depressing the input button 424b activates the drain pump 66 to drain wastewater from the inner housing 92′ to a predetermined level. The light indicator 426b is illustratively illuminated when the drain pump 66 is active. The input button 424c is illustratively a wastewater button wherein a user depressing the input button 424c controls the electrically operable valve 82 such that treated wastewater is supplied from the inner housing 92′ to the faucet 20 via the cold water outlet line 44. The light indicator 426c is illustratively illuminated to indicate this position of the electrically operable valve 82.

Although the invention has been described in detail with reference to certain preferred embodiments, variations and modifications exist within the spirit and scope of the invention as described and defined in the following claims.

1. A wastewater reuse system comprising:
a faucet;
a water treatment device fluidly coupled to a cold water source;
a wastewater tank fluidly coupled to the water treatment device to provide wastewater to the wastewater tank, the wastewater tank including;
an inner housing having a top surface and a bottom surface;
a water level sensor supported by the inner housing to detect a level of wastewater within the inner housing;
an ultraviolet light supported by the inner housing to treat the wastewater;
an electrically operable valve supported by the inner housing;
a controller operably coupled to the water level sensor, the ultraviolet light and the electrically operable valve;
wherein the wastewater tank is fluidly coupled to the faucet to provide the treated wastewater to the faucet; and
wherein the controller controls the electrically operable valve to provide selective fluid communication between the faucet and one of the cold water source or the inner housing of the wastewater tank.

2. The wastewater reuse system of claim 1, wherein the wastewater tank further includes an outer housing receiving the inner housing.

3. The wastewater reuse system of claim 2, wherein the outer housing includes a vent to prevent water pressure in the wastewater tank.

4. The wastewater reuse system of claim 2, further comprising a user interface operably coupled to the controller, the user interface including a display and an input supported on the outer housing.

5. The wastewater reuse system of claim 1, wherein the wastewater tank is fluidly coupled to a drain to facilitate drainage of excess wastewater from the inner tank.

6. The wastewater reuse system of claim 5, further comprising a drain pump operably coupled to the controller, the drain pump configured to move wastewater from the inner housing of the wastewater tank to the drain.

7. The wastewater reuse system of claim 1, wherein water treatment device is a reverse osmosis filtration system.

8. The wastewater reuse system of claim 1, further comprising a faucet pump operably coupled to the controller, the faucet pump configured to move treated wastewater from the inner housing of the wastewater tank to the faucet.

9. The wastewater reuse system of claim 1, further comprising a secondary faucet fluidly coupled to the water treatment device.

10. A wastewater reuse system comprising:
a water treatment device;
a wastewater tank fluidly coupled to the water treatment device to provide wastewater to the wastewater tank, the wastewater tank including;
a water level sensor configured to detect a level of wastewater;
an ultraviolet light configured to treat the wastewater;
an electrically operable valve; and
a controller operably coupled to the water level sensor, the ultraviolet light and the electrically operable valve.

11. The wastewater reuse system of claim 10, wherein the wastewater tank is fluidly coupled to at least one faucet to provide the treated wastewater to the at least one faucet.

12. The wastewater reuse system of claim 11, wherein the at least one faucet includes a primary faucet and a secondary faucet, wherein the wastewater tank is fluidly coupled to the secondary faucet to provide the treated wastewater to the secondary faucet.

13. The wastewater reuse system of claim 10, wherein the wastewater tank includes an outer housing, and an inner housing received within the outer housing.

14. The wastewater reuse system of claim 13, wherein the outer housing includes a vent to prevent water pressure in the wastewater tank.

15. The wastewater reuse system of claim 10, further comprising a user interface operably coupled to the controller, the user interface including a display and an input supported on the outer housing.

16. The wastewater reuse system of claim 10, wherein the wastewater tank is fluidly coupled to a drain to facilitate drainage of excess wastewater from the wastewater tank.

17. The wastewater reuse system of claim 16, further comprising a drain pump operably coupled to the controller, the drain pump configured to move wastewater from the wastewater tank to the drain.

18. The wastewater reuse system of claim 10, wherein water treatment device is a reverse osmosis filtration system.

19. The wastewater reuse system of claim 10, further comprising a faucet pump operably coupled to the controller, the faucet pump configured to move treated wastewater from the wastewater tank to at least one faucet.

20. A wastewater reuse system comprising:
a hot water source;
a cold water source;
a fluid delivery device fluidly coupled to the hot water source;
a water treatment device fluidly coupled to the cold water source;
a wastewater tank fluidly coupled to the water treatment device to provide wastewater to the wastewater tank;
an electrically operable valve fluidly coupled to the cold water source and configured to selectively provide fluid communication to the fluid delivery device from either the cold water source or the wastewater tank;
a pump configured to move treated wastewater from the wastewater tank to the fluid delivery device; and
a controller operably coupled to the electrically operable valve and the pump.

21. The wastewater reuse system of claim 20, wherein the wastewater tank includes:
a water level sensor operably coupled to the controller and configured to detect a level of wastewater in the wastewater tank; and
an ultraviolet light operably coupled to the controller and configured to treat the wastewater in the wastewater tank.

22. The wastewater reuse system of claim 20, further comprising a flow sensor operably coupled to the controller and configured to detect a flow rate of wastewater supplied to the wastewater tank.

23. The wastewater reuse system of claim 22, wherein the controller controls the electrically operable valve based upon the flow rate detected by the flow sensor.

24. The wastewater reuse system of claim 20, further comprising a water level sensor configured to detect a level of wastewater in the wastewater tank.

25. The wastewater reuse system of claim 24, wherein the wastewater tank is fluidly coupled to a drain to facilitate drainage of excess wastewater from the wastewater tank.

26. The wastewater reuse system of claim 25, further comprising a drain pump operably coupled to the controller, the drain pump configured to move wastewater from the wastewater tank to the drain based upon the wastewater level detected by the water level sensor.

27. The wastewater reuse system of claim 20, wherein water treatment device is a reverse osmosis filtration system.
